(19) United States
(12) Patent Application Publication
(10) Pub. No.: US 2010/0018466 A1
(43) Pub. Date: Jan. 28, 2010

(54) CAR DOG SEAT

(76) Inventor: Mary Austin, Chandler, AZ (US)

Correspondence Address: KEITH L. JENKINS, 2222 NORTH MCQUEEN ROAD #2069, CHANDLER, AZ, 85225, US

(21) Appl. No.: 12/506,544

(22) Filed: Jul. 21, 2009

Related U.S. Application Data
(60) Provisional application No. 61/084,005, filed on Jul. 28, 2008.

(51) Int. Cl. A01K 29/00; A01K 27/00; A01K 1/00; A47C 1/00; A47C 3/00

(52) U.S. Cl. 119/28.5

(57) ABSTRACT

A car dog seat having a cantilever support that engages the rear surface of the seat back and a frame that abuts the front surface of that seat back. The frame supports a basket which can support a small to medium-sized dog. The support may be removable, either to reorient as a handle for extra-vehicular activities or to convert the car dog seat into a dog bed at home or at a travel destination. Alternatively, the support may be reconfigurable as a handle. The frame and support are covered with a plurality of fabric coverings. A short leash is supplied, attached to the frame, to retain the dog in the car dog seat.

### RELATED APPLICATIONS

This application claims the benefit of provisional patent application Ser. No. 61/084,005 filed Jul. 28, 2008 by the same inventor, the entire contents of which are hereby incorporated by reference.

### FIELD OF THE INVENTION

The present invention relates generally to an apparatus used to support a small dog in an elevated position in an automobile. The invention further relates to a car dog seat with a support that is reconfigurable or re-orientable into a handle. The invention also relates to a car dog seat that can be reconfigured into a dog bed.

### BACKGROUND OF THE INVENTION

Small dogs (canines) have a propensity to get car sick if they can't see out the window. Accordingly, multiple attempts have been made to provide means for elevating small dogs within an automobile. U.S. Pat. No. 5,123,377 to Edwards discloses a cantilevered dog seat that uses hooks over the back of the seat. The hooks are less effective with seats having continuous integral headrests that provide no horizontal seat back surface for the hooks to engage. U.S. Pat. No. 5,785,003 to Jacobson, et al. discloses a hook-and-cantilever system like that of Edwards, but with additional supports extending to the car seat bottom. Jacobson et al. have separate hooks and handles. U.S. Pat. No. 6,564,750 to Collins discloses an elevated platform that is buttressed from the car seat bottom and has a strap around the headrest supports. U.S. Pat. No. 7,383,789 to Wilkes discloses a portable pet booster seat that rests on the car seat bottom, has sides, and has a cushion. Published Patent Application US 2005/0236874 to Godshaw et al. discloses an automobile pet bed construction that rests on the car seat bottom and is secured by ties or straps to the headrests or headrest supports. Published Patent Application US 2008/0083374 to Thomas et al. discloses a pet carrier for a vehicle that is placed between two seats with one hook support on each of the two seats. Thomas also discloses a support extending from the pet platform down to the car floor. U.S. Design Pat. No. D465,620 discloses the appearance of a pet seat made of a PVC pipe frame supporting a basket containing cushions, but no cantilever support.

Available cantilevered car dog seats are limited in their utility by their support systems to seats that are shaped to easily engage the hooks used with such systems. Other pet seats require engagement with the car seat bottom or car seat floor.

A simple, compact system usable with a wider variety of car seats that has a support which can be reconfigured as a handle or removed to create a pet bed usable outside the car, is needed. To meet this need, and to solve associated problems, the present inventor presents this invention.

### SUMMARY OF THE INVENTION

The present invention provides a frame for holding a basket sized to comfortably contain one or more small dogs, the basket, and a rigid or rigidifiable support that rests against the back of a car seat, headrest or headrest support. The support is preferably removable and re-positionable or reconfigurable. In some embodiments, the support may be reconfigurable for use as a handle. The basket may be fitted with floor and side cushions, as well as a functional and decorative skirt and a fabric covering for the frame and the support. The support may be removed to provide a dog bed in a home or hotel. Thus, the present invention is ideal for automotive travel with a small dog, providing in one invention an elevated car dog seat, a dog carrier, and a dog bed, without being unduly confining for the dog.

A car dog seat including: a frame defining a generally rectangular space; and a support coupled to the frame and operable to support the frame that is abutting only a front surface of a vehicle seat back, where the support abuts only a rear surface of the seat back. The car dog seat, further including a basket that is sized, shaped, and adapted to be securely supported by the frame. The car dog seat, where the support includes a releasably coupled support. The car dog seat 3, where the releasably coupled support is operable to either be coupled to the frame as a handle when the car dog seat is not installed in a vehicle or be removed to create a dog bed. The car dog seat, where the support includes a reconfigurable support. The car dog seat, where the reconfigurable support is operable to be reconfigured to be operable as a handle when the car dog seat is not installed in a vehicle. The car dog seat, where the frame includes a plurality of frame members. The car dog seat, including a plurality of fabric coverings over the frame and the support. The car dog seat, further including a fabric curtain coupled to the frame and extending to cover at least one side of the frame. The car dog seat, including a fabric covering for an interior of the basket. The car dog seat, including a leash releasably coupled to the frame, where the leash has a length operable to assist in retaining a dog in the car dog seat.

A car dog seat including: a frame defining a generally rectangular space and having a frame portion extending across a bottom center of such rectangular space; a support coupled to the frame and operable to support the frame abutting a front surface of a vehicle seat back; and a basket that is sized, shaped, and adapted to be securely supported by the frame. The car dog seat, where the support includes a releasably coupled support. The car dog seat, where the releasably coupled support is operable to be coupled to the frame as a handle when the car dog seat is not installed in a vehicle. The car dog seat, where the support includes a reconfigurable support. The car dog seat, where the reconfigurable support is operable to be reconfigured to be operable as a handle when the car dog seat is not installed in a vehicle. The car dog seat, where the frame includes a plurality of frame members. The car dog seat, including a plurality of fabric coverings over the frame and the support. The car dog seat, further including a fabric curtain coupled to the frame and extending to cover at least one side of the frame.

A car dog seat including: a frame including a plurality of frame members defining a generally rectangular space and having a frame member extending across a bottom center of such rectangular space; a support coupled to the frame and operable to support the frame in abutment to a front surface of a vehicle seat back, where the support includes one of: a releasably coupled support, where the releasably coupled support is operable to be coupled to the frame as a handle when the car dog seat is not installed in a vehicle or be removed to create a dog bed; and a reconfigurable support, where the reconfigurable support is operable to be reconfigured to be operable as a handle when the car dog seat is not installed in a vehicle; a basket that is sized, shaped, and adapted to be securely supported by the frame; a plurality of fabric coverings over the frame and the support; a fabric curtain coupled to the frame and extending to cover at least one side of the frame; a fabric covering for an interior of the basket; a leash releasably coupled to the frame, where the leash has a length operable to assist in retaining a dog in the car dog seat.

### BRIEF DESCRIPTION OF THE DRAWINGS

The above and other objects and advantages of the present invention will become more apparent from the following description taken in conjunction with the following drawings in which:

FIG. 1 is a side elevation view illustrating an exemplary embodiment of the improved car dog seat, in accordance with the present invention;

FIG. 2 is a photo-trace partially exploded perspective view illustrating a second exemplary embodiment of the improved car dog seat, in accordance the present invention;

FIG. 3 is a side elevation view illustrating the exemplary embodiment of the improved car dog seat of FIG. 1, in accordance with the present invention;

FIG. 4 is a side elevation view illustrating the exemplary embodiment of the improved car dog seat of FIG. 1 with the support detached, in accordance with the present invention;

FIG. 5 is a side elevation view illustrating the exemplary embodiment of the improved car dog seat of FIG. 1 with the support re-attached in a handle configuration, in accordance with the present invention;

FIG. 6 is a front elevation view illustrating the exemplary embodiment of the improved car dog seat, in accordance with the present invention;

FIG. 7 is a top plan view illustrating the exemplary embodiment of the improved car dog seat of FIG. 1, in accordance with the present invention;

FIG. 8 is a front elevation view illustrating the exemplary embodiment of the improved car dog seat of FIG. 1 with the support reconfigured as a handle, in accordance with the present invention;

FIG. 9 is a top plan view illustrating the exemplary embodiment of the improved car dog seat of FIG. 1 with the support reconfigured as a handle, in accordance with the present invention;

FIG. 10 is a side elevation view illustrating a third exemplary embodiment of the improved car dog seat, in accordance with the present invention;

FIG. 11 is a side elevation view illustrating the third exemplary embodiment of the improved car dog seat of FIG. 10 with the support in an intermediate stage of reconfiguration, in accordance with the present invention;

FIG. 12 is a side elevation view illustrating the third exemplary embodiment of the improved car dog seat of FIG. 10 with the support in reconfigured as a handle, in accordance with the present invention;

FIG. 13 is a perspective view illustrating an exemplary embodiment of the improved car dog seat with functional and decorative fabric, in accordance with the present invention; and

FIG. 14 is a perspective view illustrating an exemplary embodiment of the improved car dog seat with functional and decorative fabric and configures as a dog bed, in accordance with the present invention.

### DETAILED DESCRIPTION OF THE DRAWINGS

As used and defined herein, “car” refers to any vehicle with at least one seat for a human individual, wherein that seat has a discrete seat back with accessible front and rear surfaces.

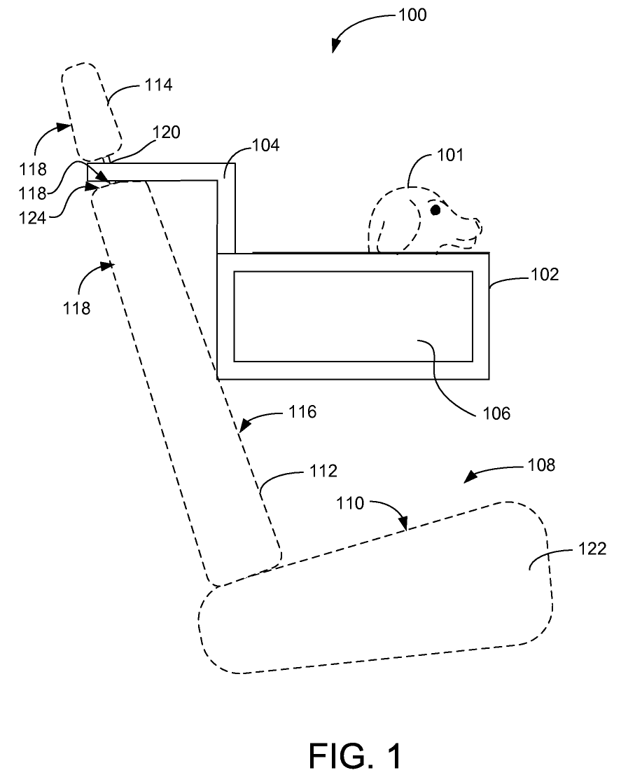

FIG. 1 is a side elevation view illustrating an exemplary embodiment of the improved car dog seat 100, in accordance with the present invention. The dog 101 rests in basket 106 that is securely supported by frame 102 that is supported, in a cantilever fashion, by both frame 102 abutting a front surface 116 of car seat back 112 and by support 104 over headrest 114 and abutting a rear surface 118 of the car seat back 112. “Rear surface 118 of the car seat back 112” as used and defined herein includes rear surfaces 118 of a seat back proper, the rear surface 118 of a headrest 114, and/or the rear surface of headrest supports 120 extending between the headrest 114 and the seat back 112. Support 104 does not abut the front surface 116 of the car seat back 112. In various embodiments and installations, support 104 may rest upon the top surface 124 of car seat back 112. The improved car dog seat 100 does not engage the top surface 110 of the bottom 122 of the car seat 108 or any other surface such as the floor of the vehicle. A car safety shoulder belt may be used to further secure the car dog seat 100 in place.

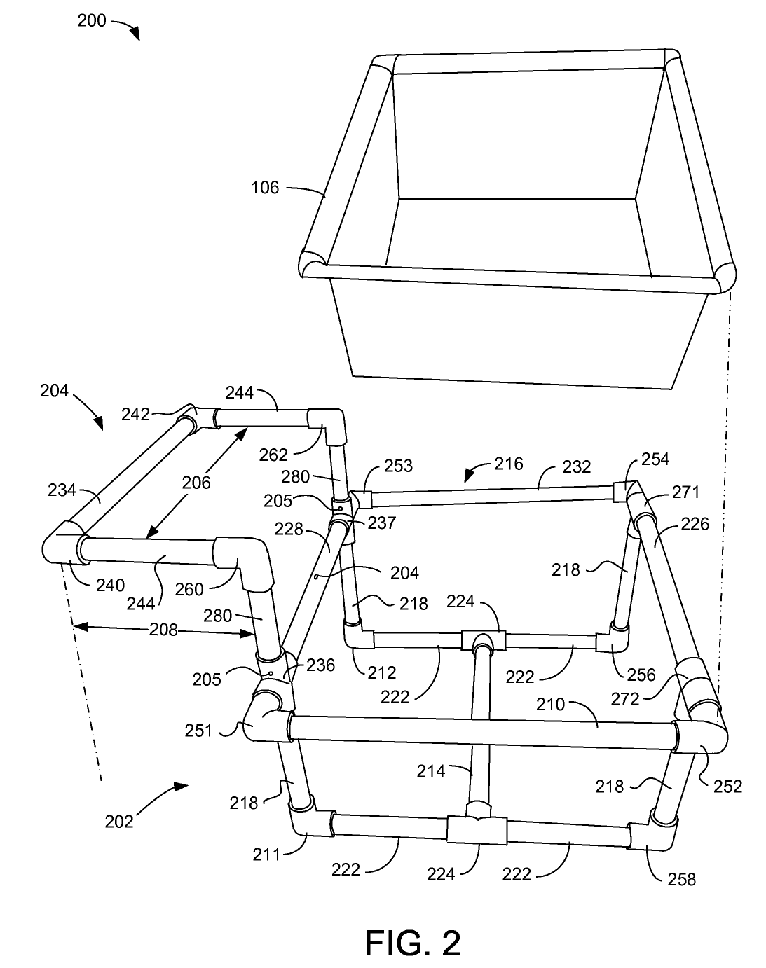

The frame 102 and support 104 may be constructed of PVC pipe (see FIG. 2) or may be molded out of plastic or other moldable material. Metals, woods, and composites may also be used in various embodiments. Bone is not preferred, due to the predilection of dogs to chew it. In a particular alternate embodiment, the frame 102 and support 104 may be formed as one piece. Basket 106 may have vents in its sides and bottom. The frame 102 may be most profitably sized to receive baskets 106 in standard sizes available in the market place. For example, a Sterilite model 1626 Ultra Storage Basket 106 available from Sterilite Corporation of Townsend, Mass. may be used, and the frame 102 sized to receive it.

FIG. 2 is a photo-trace, partially exploded, perspective view illustrating a second exemplary embodiment of the improved car dog seat 200, in accordance the present invention. The improved car dog seat includes a frame 202, a support 204, and a basket 106. The frame 202 includes a rectangular top 216 including frame members 210, 226, 228, and 232 coupled together by top corner couplings 251, 252, 253, and 254 to form a rectangular frame top section. In various alternate embodiments, shapes other than rectangular may be used. In the PVC pipe example illustrated, the coupling may include right-angle corner pieces such as 251-254. Four vertical frame members 218 depend from rectangular frame 216. Vertical frame members 218 may be coupled to members 210, 226, 228, and 232 by various conventional means, such as T-couplings 271-272 or 4-way couplings 236-237. On each side of the frame 202, front and rear vertical frame members 218 are coupled to side bottom frame members 222 by corner couplings 256, 258, 211, and 212. Proximate the middle (front-to-back) of the frame 202, center frame member 214 extends across the bottom (between the left and right side bottom frame members 222) of the rectangular space defined by the frame 202. In the PVC pipe embodiment illustrated, center frame member 214 is coupled to side bottom frame members 222 using T-couplings 224. In various alternate embodiments, other type of coupling may be used, or the center frame member 214 may be a frame portion molded in one piece with side bottom frame members 222. Center frame member 214 functions to support basket 106 underneath, while rectangular frame 216 supports at least a portion of the lip of basket 106.

Frame member 228 has a hole 204, or other adaptation, for receiving a coupling for a short leash 1308 to keep the dog 101 in the basket 106. Four-way couplings 236-237 act as releasable couplings for the support 204. Holes 205 may receive pins, screws, or the like to secure the support 204 to the frame 202. In a preferred embodiment, the couplings 236-237 between the support 204 and the frame 202 are quick-release couplings 236-237, as are known in the art of pipe joinery.

Support 204 has two vertical support members 280 which couple, preferably at right angles, to frame members 234, between which extends support member 234. Support members 244 are sized to make their length 208 roughly half the width of the frame 202. The length of support member 234 is chosen to receive headrests. Widths 206 of 10.25 inches to 14 inches are preferred. In operation, support member 204 is placed behind a seat back, headrest, or headrest supports, and corner couplings 211 and 212 of frame 202 abut the front surface of the seat back. In particular embodiments, greater or lesser widths 206 may be used. Couplings 260 and 262 are rigid in the PVC embodiment shown. Likewise, couplings 240 and 242 are preferably rigid. In embodiments where couplings 260 and 262 are not rigid, they should be capable of being made rigid while the dog care seat 200 is installed in a car.

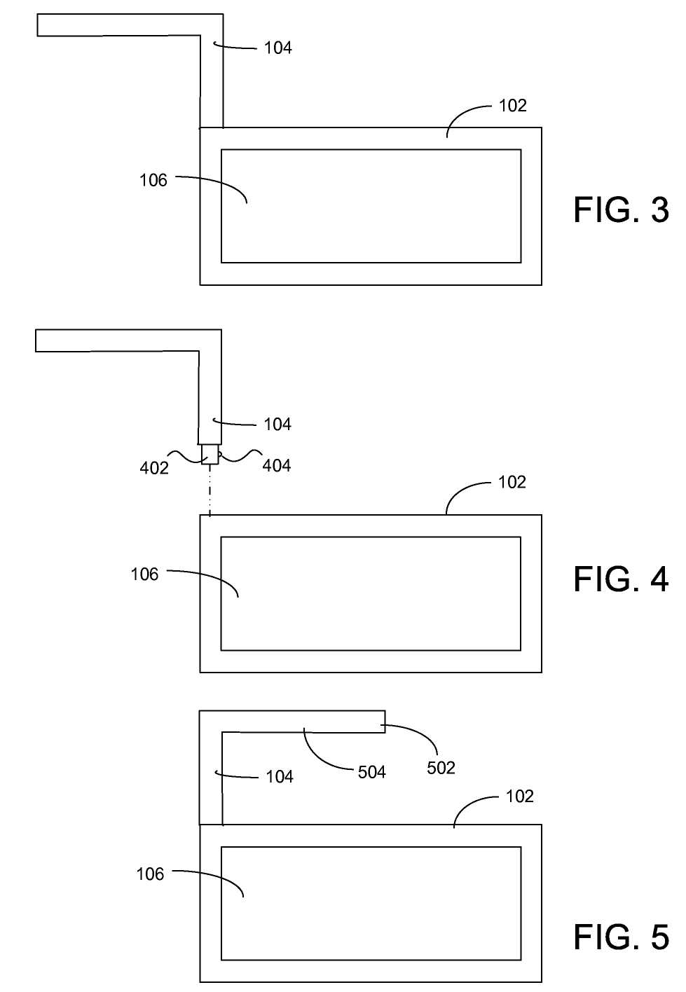

FIG. 3 is a side elevation view illustrating the exemplary embodiment of the improved car dog seat 100 of FIG. 1, in accordance with the present invention. Frame 102 and support 104 are shown configured for use with a car seat 108. Support 104 is releasably coupled to frame 102 and may be released and then re-coupled in a second orientation to serve as a handle 504 with a support 104.

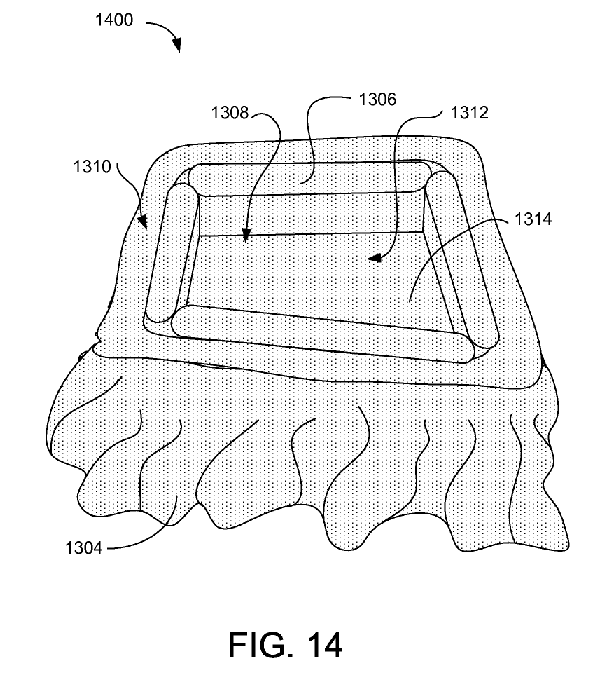

FIG. 4 is a side elevation view illustrating the exemplary embodiment of the improved car dog seat 100 of FIG. 1 with the support 104 detached, in accordance with the present invention. Support 104 has a foot 402, adapted to be received in a cavity (not shown) in frame 102. Spring-loaded retained pin 404 is preferably suitable for locking the support 104 into the frame 102 and for releasing the support 104 from the frame 102. The support may be removed for reorientation as a handle 504 or the support 104 may be removed to enable use of the car dog seat as a dog bed 1400 (see FIG. 14) in a home or at a travel destination.

FIG. 5 is a side elevation view illustrating the exemplary embodiment of the improved car dog seat 100 of FIG. 1 with the support 104 re-attached in a handle configuration, in accordance with the present invention. Handle 504 end 502 is preferably above the center of mass of the frame 102 and basket 106 combination when support 104 is reoriented as a handle 504.

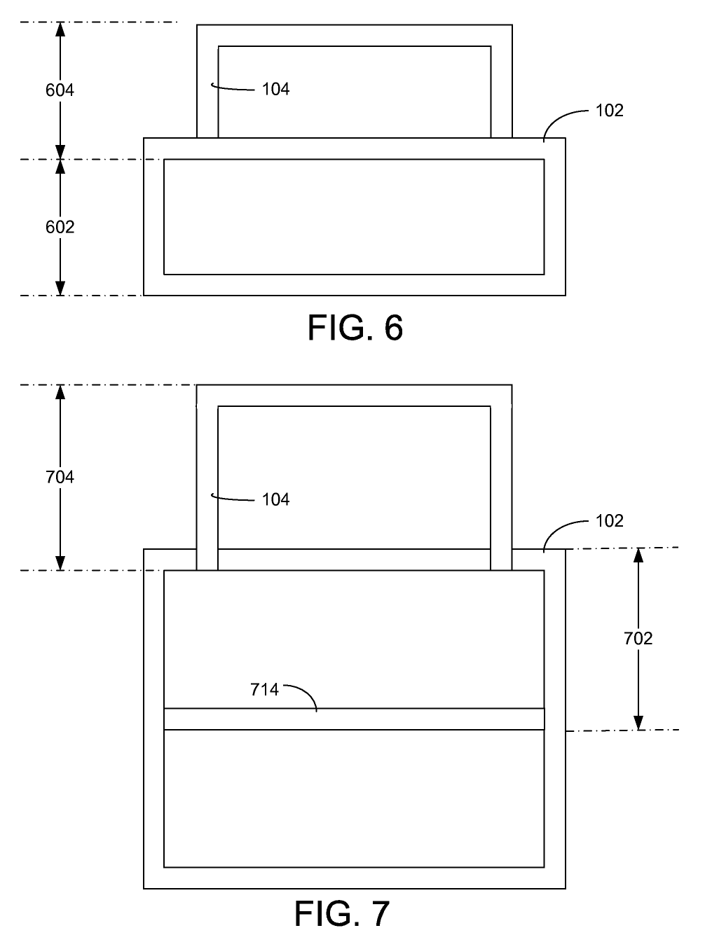

FIG. 6 is a front elevation view illustrating the exemplary embodiment of the improved car dog seat 100 of FIG. 1, in accordance with the present invention. Support 104 is attached to frame 102. The height 604 is preferably similar to height 602.

FIG. 7 is a top plan view illustrating the exemplary embodiment of the improved car dog seat 100 of FIG. 1, in accordance with the present invention. A center member 714 for car dog seat 100 is visible. The height 704 is preferably similar to height 702.

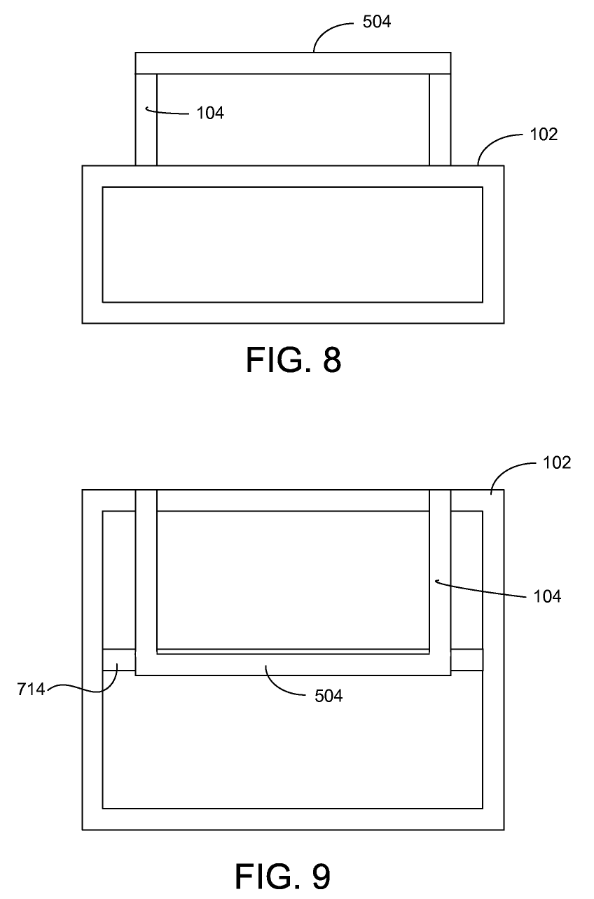

FIG. 8 is a front elevation view illustrating the exemplary embodiment of the improved car dog seat 100 of FIG. 1 with the support 104 reconfigured as a handle 802, in accordance with the present invention. Support 104 is attached to frame 102 as a handle 504 for carrying the car dog seat 100 and dog 101.

FIG. 9 is a top plan view illustrating the exemplary embodiment of the improved car dog seat 100 of FIG. 1 with the support 104 reconfigured as a handle, in accordance with the present invention. In this illustration, support 104 extends slightly more than half way across frame 102. It is preferable for the handle 802 to be above the center of mass of the frame 102. Support 104/handle 802 must be strong enough to carry cantilevered loads in either position.

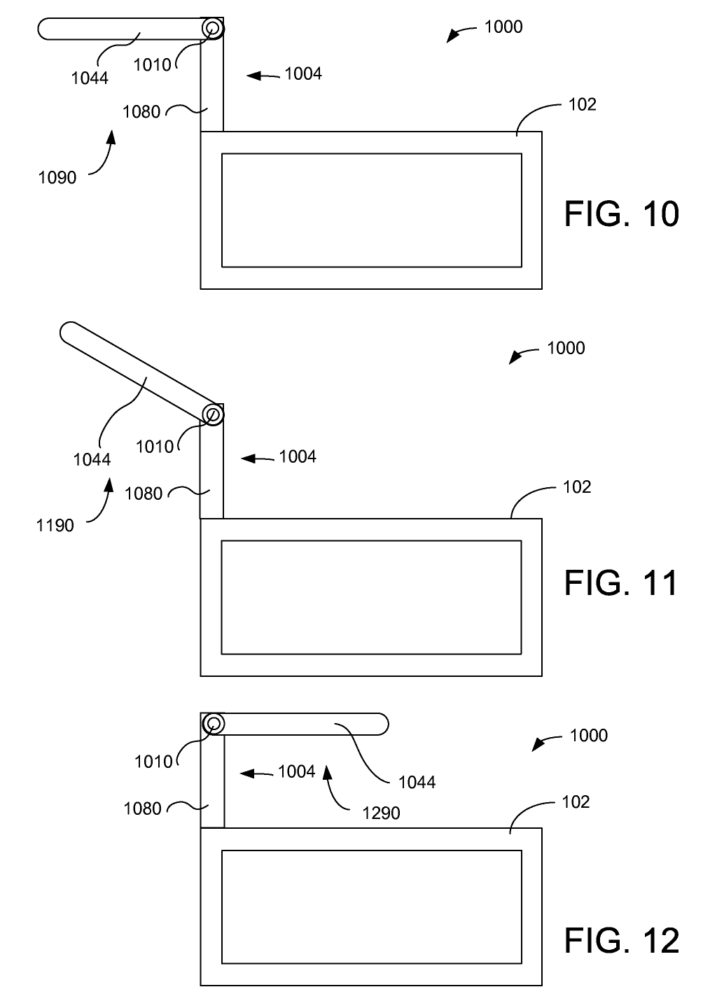

FIG. 10 is a side elevation view illustrating a third exemplary embodiment of the improved car dog seat 1000, in accordance with the present invention. Reconfigurable support 1004, replacing support 104, is reconfigurable by means of a bi-stable rotational joint 1010 between vertical support 1080 (replacing vertical support 280 from FIG. 2) and support member 1044 (replacing support member 244 from FIG. 2). To reconfigure from the support configuration 1090 to the handle configuration 1290, the joint 1010 may be released to rotate to the handle configuration 1290, where it releasably locks in place. Reconfiguring back to the support configuration 1090 is accomplished in reverse.

FIG. 11 is a side elevation view illustrating the third exemplary embodiment of the improved car dog seat 1000 of FIG. 10 with the support 1004 in an intermediate stage of reconfiguration 1190, in accordance with the present invention. The intermediate configuration 1190 shown is preferably not stable.

FIG. 12 is a side elevation view illustrating the third exemplary embodiment of the improved car dog seat 1000 of FIG. 10 with the support 1004 in reconfigured as a handle 1290, in accordance with the present invention. The handle configuration 1290 is a stable configuration. Bi-stable rotational joint 1010 must be strong enough to hold against the cantilevered load.

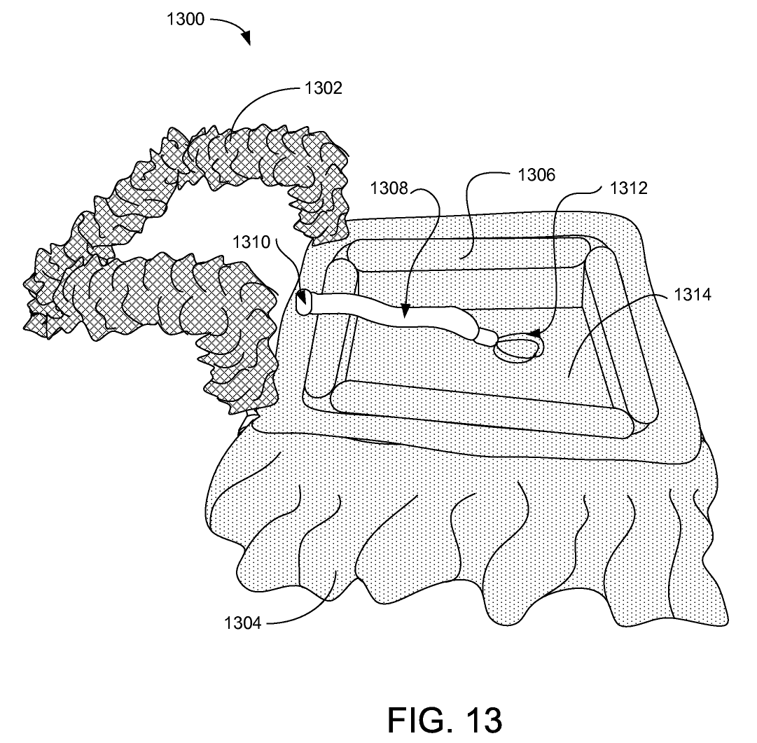

FIG. 13 is a perspective view illustrating exemplary embodiments of the improved car dog seat 1300 with functional and decorative fabrics, in accordance with the present invention. Any of the embodiments 100, 200, 1000 shown may be provided with fabric configured as a basket floor covering or cushion 1314, side coverings or cushions 1306 to form car dog seat 1300. Short leash 1308 is coupled to the frame 102 or 202 using a conventional coupling 1310. Short leash 1308 may have a clip 1312 for attaching to the harness of dog 101. A harness is referred over a collar, against the possibility that the dog might be thrown from the car dog seat 1300 and hang by the leash 1308. Skirt 1304 covers at least one side, and preferably all sides, of frame 102 or 202. Skirt 1304, like the other fabric items, is removable and washable. Skirt 1304 serves the function of assisting in keeping the frame 102 or 202 clean. A tube of cloth 1302 is made to cover the support with multiple gathers, forming a “scrunchy” covering. The tube of cloth 1302 assists in keeping the support 104, 204, or 1004 clean. The fabrics also have decorative attributes, which assists in the function of making sales.

FIG. 14 is a perspective view illustrating an exemplary embodiment of the improved car dog seat 100, 200, or 1000, with functional and decorative fabric and configured as a dog bed 1400, in accordance with the present invention. With the support 104, 204, or 1004 removed, the car dog seat 100, 200, or 1000 becomes a dog bed 1400. In an alternate embodiment, the support 1004 may have a third stable state in a vertical position, creating a dog bed that can be picked up without bending down quite as far.

Although applicant has described applicant's preferred embodiments of this invention, it will be understood that the broadest scope of this invention includes such alternate embodiments as those using diverse types of baskets 106, fabrics 1302, 1304, 1306, and 1314, frame 102 members and construction methods, and support 104 members and construction methods. Such scope is limited only by the below claims as read in connection with the above specification.

Further, many other advantages of applicant's invention will be apparent to those skilled in the art from the above descriptions and the below claims.

I claim:

1. A car dog seat comprising:
a. a frame defining a generally rectangular space; and
b. a support coupled to said frame and operable to support said frame that is abutting only a front surface of a vehicle seat back, wherein said support abuts only a rear surface of said seat back.

2. The car dog seat of claim 1, further comprising a basket that is sized, shaped, and adapted to be securely supported by said frame.

3. The car dog seat of claim 1, wherein said support comprises a releasably coupled support.

4. The car dog seat of claim 3, wherein said releasably coupled support is operable to one of:
a. be coupled to said frame as a handle when said car dog seat is not installed in a vehicle; and
b. be removed to create a dog bed.

5. The car dog seat of claim 1, wherein said support comprises a reconfigurable support.

6. The car dog seat of claim 5, wherein said reconfigurable support is operable to be reconfigured to be operable as a handle when said car dog seat is not installed in a vehicle.

7. The car dog seat of claim 1, wherein said frame comprises a plurality of frame members.

8. The car dog seat of claim 7, comprising a plurality of fabric coverings over said frame and said support.

9. The car dog seat of claim 1, further comprising a fabric curtain coupled to said frame and extending to cover at least one side of said frame.

10. The car dog seat of claim 1, comprising a fabric covering for an interior of said basket.

11. The car dog seat of claim 1, comprising a leash releasably coupled to said frame, wherein said leash has a length operable to assist in retaining a dog in said car dog seat.

12. A car dog seat comprising:
a. a frame defining a generally rectangular space and having a frame portion extending across a bottom center of such rectangular space;
b. a support coupled to said frame and operable to support said frame abutting a front surface of a vehicle seat back; and
c. a basket that is sized, shaped, and adapted to be securely supported by said frame.

13. The car dog seat of claim 12, wherein said support comprises a releasably coupled support.

14. The car dog seat of claim 13, wherein said releasably coupled support is operable to:
a. be coupled to said frame as a handle when said car dog seat is not installed in a vehicle; and
b. be removed to create a dog bed.

15. The car dog seat of claim 12, wherein said support comprises a reconfigurable support.

16. The car dog seat of claim 15, wherein said reconfigurable support is operable to be reconfigured to be operable as a handle when said car dog seat is not installed in a vehicle.

17. The car dog seat of claim 12, wherein said frame comprises a plurality of frame members.

18. The car dog seat of claim 17, comprising a plurality of fabric coverings over said frame and said support.

19. The car dog seat of claim 12, further comprising a fabric curtain coupled to said frame and extending to cover at least one side of said frame.

20. A car dog seat comprising:
a. a frame comprising a plurality of frame members defining a generally rectangular space and having a frame member extending across a bottom center of such rectangular space;
b. a support coupled to said frame and operable to support said frame in abutment to a front surface of a vehicle seat back, wherein said support comprises one of:
i. a releasably coupled support, wherein said releasably coupled support is operable to be one of:
1. coupled to said frame as a handle when said car dog seat is not installed in a vehicle; and
2. removed to create a dog bed; and
ii. a reconfigurable support, wherein said reconfigurable support is operable to be reconfigured to be operable as a handle when said car dog seat is not installed in a vehicle;
c. a basket that is sized, shaped, and adapted to be securely supported by said frame;
d. a plurality of fabric coverings over said frame and said support;
e. a fabric curtain coupled to said frame and extending to cover at least one side of said frame;
f. a fabric covering for an interior of said basket;
g. a leash releasably coupled to said frame, wherein said leash has a length operable to assist in retaining a dog in said car dog seat.
